(19) United States
(12) Patent Application Publication
(10) Pub. No.: US 2021/0295170 A1
(43) Pub. Date: Sep. 23, 2021

(54) REMOVAL OF ENGAGEMENT BIAS IN ONLINE SERVICE

(71) Applicant: Microsoft Technology Licensing, LLC, Redmond, WA (US)

(72) Inventors: Parag Agrawal, Mountain View, CA (US); Aastha Jain, Sunnyvale, CA (US); Ankan Saha, San Francisco, CA (US); Ayan Acharya, Santa Clara, CA (US)

(21) Appl. No.: 16/821,198

(22) Filed: Mar. 17, 2020

(51) Int. Cl. G06N 3/08; G06N 3/04; G06Q 50/00

(52) U.S. Cl. CPC G06N 3/088; G06Q 50/01; G06N 3/0454; G06N 3/0472

(57) ABSTRACT

Methods, systems, and computer programs are presented for removing bias among users of an online service based on the amount of user's participation in the online service. One method includes operation for pre-training an invite model that provides a first score associated with a user of an online service and for pre-training an adversarial model that provides a second score, the adversarial model having the first score as an input. Further, the method includes training together the invite model and the adversarial model using an adversarial cost function based on the pre-training of the invite model and the adversarial model. The training together is repeated until discrimination of the invite model is below a predetermined threshold. Further, the invite model is utilized to generate the first scores, where the invite model generates the first scores without bias.

### TECHNICAL FIELD

The subject matter disclosed herein generally relates to methods, systems, and machine-readable storage media for removing bias among users of an online service based on the amount of user's participation in the online service.

### BACKGROUND

There are different types of users on an online service according to their level of engagement with the online service: from very-frequent users (e.g., daily visitors), referred to herein as engaged users, to occasional users that visit once a month or less, referred to herein as infrequent users.

When calculating online-service parameters, such as statistics on user activities, the engaged users will heavily contribute to these statistical values. However, this may cause distortion on the effect of the infrequent users on the online service. For example, when measuring the impact of a new feature on the online service, the test results will often be biased towards the behaviors and attitudes of the engaged users, because they will be providing more data points. This is referred to as engagement bias.

With the proliferation of Artificial Intelligence (AI) systems, it is becoming increasingly important to develop algorithms that are unprejudiced and fair. Each user should get her fair share of representation in the AI algorithms that support the online service, such as a professional social networking service.

Removing engagement bias is an important step towards implementing fairness. What is needed is a way to eliminate the engagement bias to allow the online service to provide a better service to the users.

### BRIEF DESCRIPTION OF THE DRAWINGS

Various of the appended drawings merely illustrate example embodiments of the present disclosure and cannot be considered as limiting its scope.

FIG. 1 is a user interface for recommending new social connections to a user of an online service, according to some example embodiments.

FIG. 2 is a block diagram illustrating a networked system, according to some example embodiments, illustrating an example embodiment of a high-level client-server-based network architecture.

FIG. 3 illustrates the problems associated with result bias introduced when analyzing data for engaged users and infrequent users, according to some example embodiments.

FIG. 4 is an adversarial network architecture for removing engagement bias, according to some example embodiments.

FIG. 5 is a flowchart of a method for training the adversarial models, according to some example embodiments.

FIG. 6 is an example of a pInvite neural network, according to some example embodiments.

FIG. 7 is an example of an adversarial neural network, according to some example embodiments.

FIG. 8 illustrates the training and use of a machine-learning program, according to some example embodiments.

FIG. 9 is a flowchart of a method for removing bias among users of an online service based on the amount of user's participation in the online service.

FIG. 10 is a block diagram illustrating an example of a machine upon or by which one or more example process embodiments described herein may be implemented or controlled.

### DETAILED DESCRIPTION

Example methods, systems, and computer programs are directed to removing bias among users of an online service based on the amount of user's participation in the online service.

One general aspect includes a method that includes an operation for pre-training an invite model that provides a first score associated with a user of an online service and for pre-training an adversarial model that provides a second score, where the adversarial model has the first score as an input. Further, the method includes training together the invite model and the adversarial model using an adversarial cost function based on the pre-training of the invite model and the adversarial model. The training together is repeated until discrimination of the invite model is below a predetermined threshold. Further, the invite model is utilized to generate the first scores, where the invite model generates the first scores without bias. In one aspect, the removal of bias is performed using a generative adversarial network (GAN).

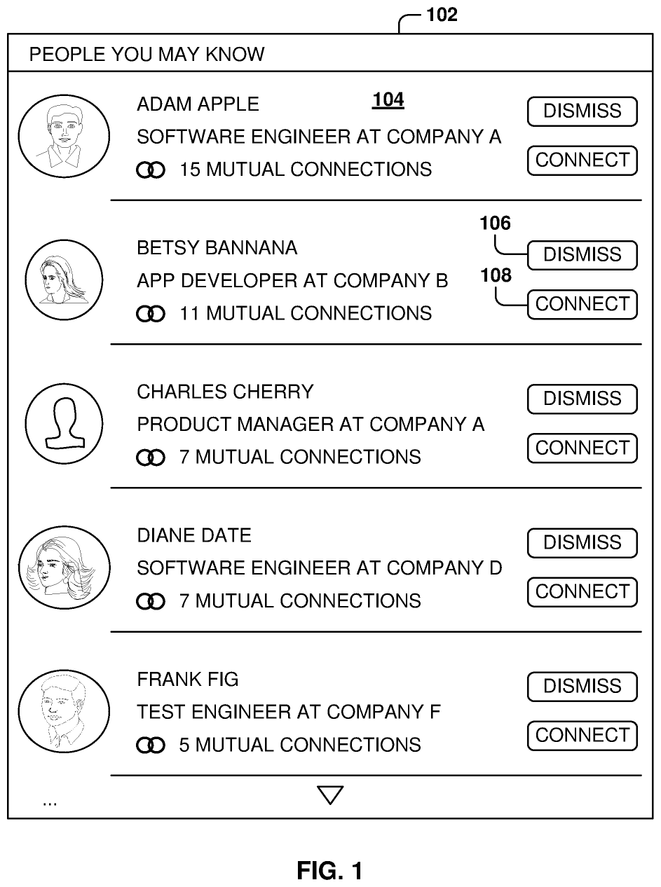

FIG. 1 is a people-you-may know (PYMK) user interface 102 for recommending new social connections to a user of an online service (e.g., a social networking service), according to some example embodiments. The PYMK user interface 102 includes PYMK suggestions for a particular user of the social networking service. It is noted that the PYMK search for possible new connections may be initiated by the user by selecting an option in the online service, or the PYMK search may be initiated by the system and presented in some part of the online service user interface as an option with some initial suggestions.

The PYMK user interface 102 presents a plurality of user suggestions 104 and scrolling options for seeing additional suggestions. In some example embodiments, each user suggestion 104 includes the profile image of the user, the user's name, the user's title, the number of mutual connections, an option to dismiss 106 the user suggestion, and an option to request connecting 108 to the user suggestion. Mutual connections between two users of the online service are people in the online service that are directly connected to both users.

When the user selects the dismiss option 106, the dismissal is recorded by the online service so that user is not suggested again. When the user selects the connect option 108, the online service sends an invitation to the selected user for becoming a connection. Once the selected user accepts the invitation, then both users become connections in the online service.

It is noted that the embodiments illustrated in FIG. 1 are examples and do not describe every possible embodiment. Other embodiments may show a different number of suggestions, include additional data for each suggestion or less data, present the suggestions in a different layout within the user interface, and so forth. The embodiments illustrated in FIG. 1 should therefore not be interpreted to be exclusive or limiting, but rather illustrative.

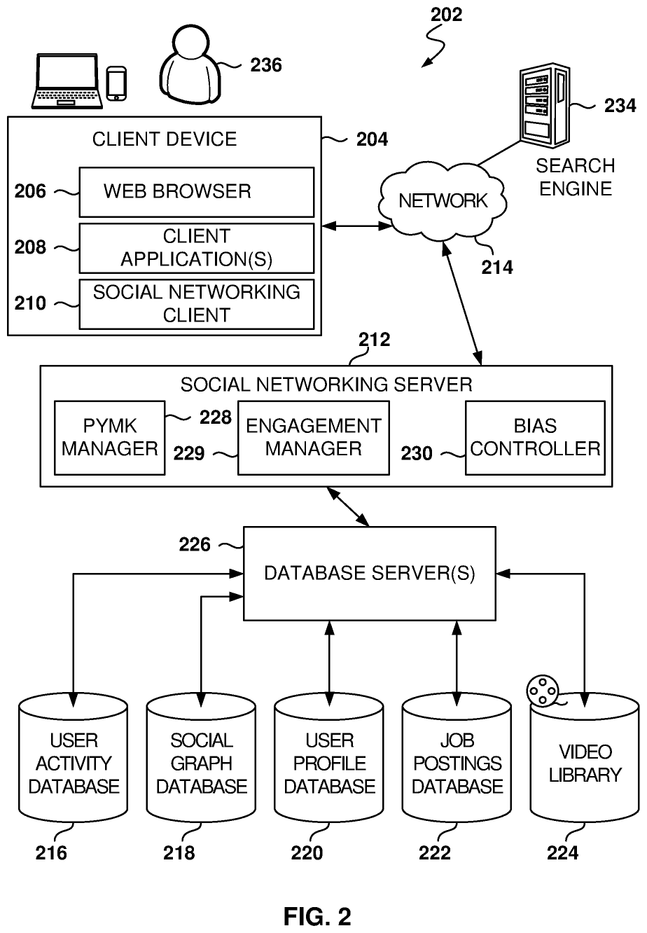

FIG. 2 is a block diagram illustrating a networked system, according to some example embodiments, including a social networking server 212, illustrating an example embodiment of a high-level client-server-based network architecture 202. Embodiments are presented with reference to an online service and, in some example embodiments, the online service is a social networking service.

The social networking server 212 provides server-side functionality via a network 214 (e.g., the Internet or a wide area network (WAN)) to one or more client devices 204. FIG. 2 illustrates, for example, a web browser 206, client application(s) 208, and a social networking client 210 executing on a client device 204. The social networking server 212 is further communicatively coupled with one or more database servers 226 that provide access to one or more databases 216-224.

The social networking server 212 includes, among other modules, a PYMK manager 228, and engagement manager 229, and a bias controller 230. The PYMK manager 228 manages the PYMK service, which includes providing PYMK recommendations to users. The engagement manager 229 tracks the level of engagement of users with the social networking service, and the bias controller 230 performs operations to eliminate the bias in the online service based on the engagement level.

The client device 204 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 236 may utilize to access the social networking server 212. In some embodiments, the client device 204 may comprise a display module (not shown) to display information (e.g., in the form of user interfaces).

In one embodiment, the social networking server 212 is a network-based appliance that responds to initialization requests or search queries from the client device 204. One or more users 236 may be a person, a machine, or other means of interacting with the client device 204. In various embodiments, the user 236 interacts with the network architecture 202 via the client device 204 or another means.

The client device 204 may include one or more applications (also referred to as “apps”) such as, but not limited to, the web browser 206, the social networking client 210, and other client applications 208, such as a messaging application, an electronic mail (email) application, a news application, and the like. In some embodiments, if the social networking client 210 is present in the client device 204, then the social networking client 210 is configured to locally provide the user interface for the application and to communicate with the social networking server 212, on an as-needed basis, for data and/or processing capabilities not locally available (e.g., to access a user profile, to authenticate a user 236, to identify or locate other connected users 236, etc.). Conversely, if the social networking client 210 is not included in the client device 204, the client device 204 may use the web browser 206 to access the social networking server 212.

In addition to the client device 204, the social networking server 212 communicates with the one or more database servers 226 and databases 216-224. In one example embodiment, the social networking server 212 is communicatively coupled to a user activity database 216, a social graph database 218, a user profile database 220, a job postings database 222, and a video library 224. The databases 216-224 may be implemented as one or more types of databases including, but not limited to, a hierarchical database, a relational database, an object-oriented database, one or more flat files, or combinations thereof.

The user profile database 220 stores user profile information about users 236 who have registered with the social networking server 212. With regard to the user profile database 220, the user 236 may be an individual person or an organization, such as a company, a corporation, a nonprofit organization, an educational institution, or other such organizations.

In some example embodiments, when a user 236 initially registers to become a user 236 of the social networking service provided by the social networking server 212, the user 236 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database 220. Similarly, when a representative of an organization initially registers the organization with the social networking service provided by the social networking server 212, the representative may be prompted to provide certain information about the organization, such as a company industry.

As users 236 interact with the social networking service provided by the social networking server 212, the social networking server 212 is configured to monitor these interactions. Examples of interactions include, but are not limited to, commenting on posts entered by other users 236, viewing user profiles, editing or viewing a user 236's own profile, sharing content outside of the social networking service (e.g., an article provided by an entity other than the social networking server 212), updating a current status, posting content for other users 236 to view and comment on, posting job suggestions for the users 236, searching job postings, and other such interactions. In one embodiment, records of these interactions are stored in the user activity database 216, which associates interactions made by a user 236 with his or her user profile stored in the user profile database 220.

The job postings database 222 includes job postings offered by companies. Each job posting includes job-related information such as any combination of employer, job title, job description, requirements for the job posting, salary and benefits, geographic location, one or more job skills desired, day the job posting was posted, relocation benefits, and the like.

The video library 224 includes videos uploaded to the social networking service, such as videos uploaded by users. In other example embodiments, the video library 224 may also include other videos, such as videos downloaded from websites, news, other social networking services, etc.

While the database server(s) 226 are illustrated as a single block, one of ordinary skill in the art will recognize that the database server(s) 226 may include one or more such servers. Accordingly, and in one embodiment, the database server(s) 226 implemented by the social networking service are further configured to communicate with the social networking server 212.

The network architecture 202 may also include a search engine 234. Although only one search engine 234 is depicted, the network architecture 202 may include multiple search engines 234. Thus, the social networking server 212 may retrieve search results (and, potentially, other data) from multiple search engines 234. The search engine 234 may be a third-party search engine.

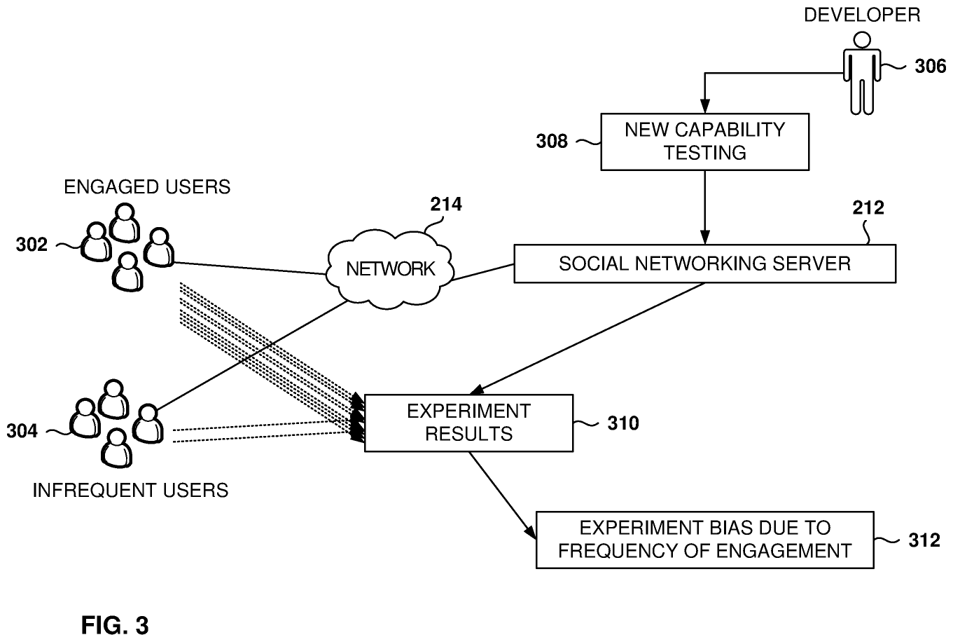

FIG. 3 illustrates the problems associated with result bias introduced when analyzing data for engaged users and infrequent users, according to some example embodiments. In one scenario, a developer 306 creates a new feature or capability for the online service. The developer 306 performs testing 308 of the new capability by adding the new capability to the online service provided by the social networking server 212.

The new feature is tested over a period of time (e.g., two weeks) and experiment results 310 are captured. However, experiment bias 312, also referred to as engagement bias, is often found in the experiment results 310 because the engaged users 302 provide a bigger number of data points for the experiments.

The engaged users 302 are those users that access the online service frequently (e.g., daily), while the infrequent users 304 are those users that do not access the online service frequently. Although only two categories of users are illustrated, other embodiments may categorize users in more than two categories based on their engagement levels.

In some example embodiments, five categories of users are defined according to their engagement level: 4×4, 1×3, 1×1, dormant, and onboarding. The 4×4 user engages daily with the online service, the 1×3 user engages at least once a week, and the 1×1 user engages at least once a month. The dormant users are users that have been inactive for more than a month, and the onboarding users are those that recently joined the online service. In one example embodiment, the engaged users 302 include the 4×4 and 1×3 users, and the infrequent users include the 1×1, dormant, and onboarding users.

For example, in the case of PYMK, engagement bias is caused by training data that is heavily populated by the engaged users. Any model fitted over this data would essentially replicate the engagement bias in order to maximize the accuracy of the fit, leading to a prejudiced and unfair model.

This engagement bias has negative effects for several reasons. First, the results will reflect the behaviors of engaged users, which means that the system will tend to favor the engaged users 302 to the detriment of the infrequent users 304. As a result, there will not be enhancements that benefit the infrequent users 304. For example, generating suggestions for PYMK will improve for the engaged users 302, but not for the infrequent users 304.

Second, the infrequent users 304 have much more room for improvement with regards to engagement with the online service, so making the service better for the infrequent users 304 can generate bigger returns on user activities.

Additionally, there is an issue of AI fairness. Since engaged users 302 are frequent users, the online service is able to collect information about the preferences of the engaged users 302. However, the service may not have as much information on the infrequent users 304 to make inferences. In general, AI, and in particular machine learning (ML), uses large amounts of data to find correlations in the data, so the more data available, the better the results. Since there is not as much data for the infrequent users 304, the AI algorithms will not perform as well for them. Therefore, there is a goal to provide fairness to the AI algorithms.

The removal of engagement bias has several benefits, such as long-term gains, growth opportunity, accurate measurements, and faster experimentation velocity. Removing engagement bias helps PYMK collect long-term gains from showing unengaged users more often. Unengaged users drive long term retention and resurrection metrics. Further, suggesting engaged users 302, at expense of the infrequent users 304, provides smaller gains in the number of new connections, as the engaged users 302 are already well connected. Removing the engagement bias lets infrequent users 304 grow their network, which has more potential for the online service because infrequent users have larger room to grow their network.

Additionally, engagement bias leads to short-term quicker metric gains which dwindle over-time. This leads to inaccurate measurements and wrong conclusions from running an experiment. Removing the engagement bias, provides accurate read of metrics from experiments. Further, experiments without the bias no longer have early dominating results. This means that it is not necessary to run experiments for longer times to get correct biased results; thus, improving the experimentation velocity and throughput of experiments.

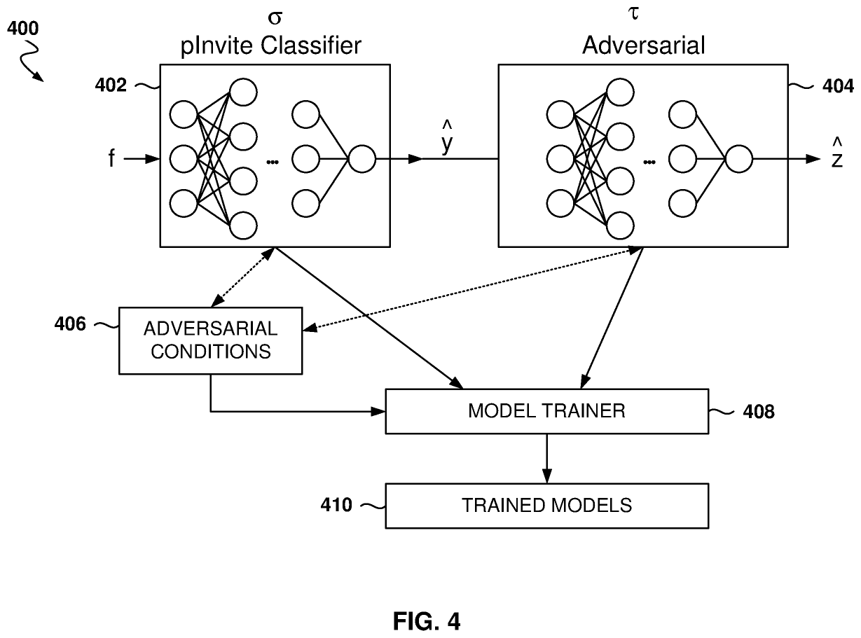

FIG. 4 is an adversarial network architecture 400 for removing engagement bias, according to some example embodiments. In some example embodiments, the adversarial network architecture 400 is a generative adversarial network (GAN) and includes a pInvite classifier 402, which is a classifier neural network also referred to as σ, and an adversarial neural network 404 referred to as τ.

The pInvite classifier 402 is a model that optimizes the probability of sending an invitation to connect when a suggestion is presented to a user, while the adversarial neural network 404 is a model that optimizes the probability of predicting that the recipient of the invitation is an engaged user.

Let f be the features (or covariates) and a σ nonlinear parametric function which are being used to predict the probability of sending an invite from one user to another. The estimated function 6 is associated with the pInvite classifier, referred to also as the pInvite model. In some example embodiments, the category of engagement is not one of the features in f, that is, the engagement is not used for predicting the probability of invitation.

Using y to represent the response variable of σ (probability of the invitation sent), the goal is to estimate the unknown parametric function in the following equation:

log it(yᵢⱼ)˜σ(fᵢⱼ) (1)

In equation (1), yᵢⱼ is 1 if source user i sends an invite to a destination user j, otherwise it is 0. In some example embodiments, a period is defined for counting if the invitation is sent or not, such as a week. If the invitation is sent sometime during the measurement week, the yᵢⱼ is 1 and if no invitation is sent then 0. Other embodiments may used other time windows, such as in the range from 1 day to 365 days.

Further, iris the unknown parametric function to be estimated, and fᵢⱼ is the set of features of the user i and for the pair (i,j) (excluding the engagement category). The features of the user may include any information captured in the user profile, captured based on the user activity, and derived from the user profile and activities. For example, the user's job title, the user's education, how many connections the user has on the online service, etc.

In some example embodiments, the estimated σ values for multiple possible destinations j are ranked and the destination top σ values are selected to be presented as suggestions for possible new connections for user i. That is, the σ value determines which suggestions of possible new connections are presented to the user.

It is noted that although embodiments are presented with reference to PYMK, the same principles may be used for other functions, such as to select items for the user's feed, to find job suggestions for the user, and to select notifications to be sent to the user.

In statistics, the log it function is the logarithm of the odds of a probability p divided by (1−p). The log it function creates a map of probability values from (0, 1) to (−∞,+∞). In deep learning, the term log its layer is popularly used for the last neuron layer of neural networks used for classification tasks, which produce raw prediction values as real numbers ranging from (−∞, +∞). Basically, the log it function maps a value to a real number between 0 and 1.

In a system without the adversarial network, the unknown parametric function σ is estimated by solving the following optimization over the training dataset D:

pInvite Model=\hat{σ}=argmin_{σ}[L(y,σf),D] (2)

Here, L is a cross-entropy loss function. Since the training data D is mostly populated by engaged users, the pInvite classifier has the implicit engagement bias, which is removed using GAN.

With the debiased model (e.g., debiased PYMK model) using GAN, the generative network is the pInvite classifier 402 and the adversarial network is τ. The τ takes the output from the pInvite classifier 402 as an input to predict z, which is a probability that the destination user (of the invite) is an engaged user.

In some example embodiments, the training data D is collected over a period of time, such as two months. The PYMK activities of users on the online service are logged, such as when users are sending invitations to people in response to PYMK suggestions, or when users look at profiles of other users. In other embodiments, other time collection periods may be used (e.g., two weeks, four months, six months).

The adversarial conditions 406 include that the adversarial network is trying to estimate the unknown parametric function i in the following equation:

log it(zᵢⱼ)˜τ(σ(fᵢⱼ)) (3)

Here, zᵢⱼ is 1 if the destination user j is an engaged user and 0 otherwise. The zero-sum game that the generative and adversarial networks are engaged in is captured by a minimax loss function to be optimized.

The generative-network estimates a (e.g., pInvite model) by solving the following optimization problem:

\hat{σ}=argmin_{σ}[L(y,σf)−λL(z,τ(σ(f))),D] (4)

In equation (4), L is a log-loss function. In mathematics, the arguments of the minima (abbreviated arg min or argmin) are the points, or elements, of the domain of some function at which the function values are minimized. Because the term including the τ model has a negative sign, minimizing equation (4) means maximizing the τ loss; that is, the probability of being an engaged user or not is about 50% (corresponding to a random pick). The “adversarial” name comes from maximizing one value while minimizing the other. In other words, can the system predict the engagement level based on the estimated \hat{σ}?

With this adversarial condition in equation (4), the pInvite model is not only minimizing its prediction loss but also maximizing the loss of the adversarial network τ. The λ is a hyperparameter that can be tuned to balance the quality of the invitations versus the amount of bias. Higher values of λ will reduce the bias at the expense of some loss in the quality of the invitation suggestions.

Thus, the pInvite model's objective is twofold: make the best invitations predictions while ensuring that the level of engagement cannot be derived from the invitations. That is, it is not possible to predict from a given invitation, whether the invited user is an engaged user or an infrequent user. If it is possible to predict that a user is an engaged user based on the invitation, then there is bias.

On the other hand, the adversarial network r needs to minimize its own prediction loss and does not worry about the classifier's loss, as follows:

\hat{τ}=argmin_{τ}[L(z,τ(σ(f))),D] (5)

In the absence of bias, \hat{τ} should be a random number, that is, is about 50% on average that the destination user is an engaged user.

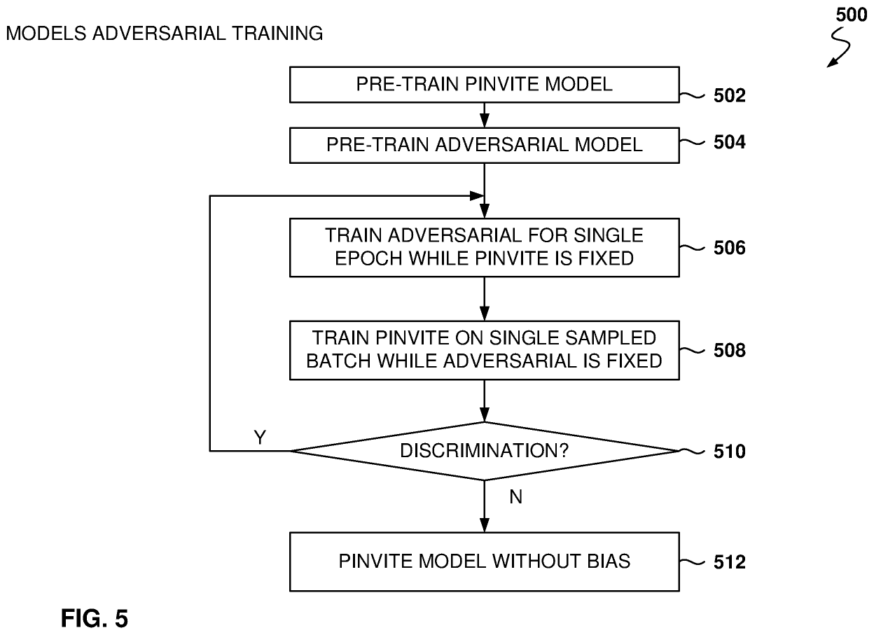

After the adversarial conditions 406 are set, the models are trained at operation 408, resulting in trained models 410 that eliminate bias. More details regarding the training are provided below with reference to FIG. 5.

FIG. 5 is a flowchart of a method 500 for training the adversarial models, according to some example embodiments. At operation 502, the pInvite model is pre-trained with the dataset D by solving equation (2).

From operation 502, the method flows to operation 504 where the adversarial model is pre-trained on the predictions of the pre-trained classifier from operation 502.

After operation 504, a number of iterations T are performed for operations 506 and 508. At operation 506, the r is trained for a single epoch while keeping the classifier fixed. Further, at operation 508, the pInvite classifier is trained on a single sampled mini batch while keeping the r fixed.

The number of iterations T depends on the discriminatory power of r, such that at the end of T iterations, the r would not be able to discriminate between engaged and unengaged users (since adversary's loss was maximized), ensuring that the pInvite classifier is now unprejudiced and free of engagement bias.

At operation 510, a check is made to determine if r is able to discriminate more than a predetermined level. If the answer is yes, then the method flows to operation 506 for another iteration; otherwise, the method flows to operation 512. At operation 512, the pInvite model has been trained without engagement bias.

It is noted that the training process may involve instability because we are minimizing something and maximizing something at the same time. There may not be an optimal state where one is minimized and the other one is maximized. This is why the pre-training of operations 502 and 504 are performed first to train the pInvite model alone and the adversarial model alone to provide a better starting point for the iterations with the adversarial training.

During operations 506 and 508, the offsets obtained in 502 and 504 are used as starting points, referred to as a warm start. For example, if a parameter for the pInvite model is estimated as 20 during 502, for 508, the parameter is redefined as 20 plus a new value of the parameter. That is, the offset of 20 is introduced. This could be one of the parameters used for the neural network. The warm start increases the probability of finding convergence, that is, a stable model without engagement bias.

It is noted that when the models are trained separately, both models are based on minimizing. However, during the adversarial join training, one model is maximized and another model is minimized.

In some example embodiments, offline metrics are used for the adversarial system. Receiver Operating Characteristic Area Under Curve (ROC AUC) and accuracy are used for measuring the prediction performance of the pInvite model, and the p %-rule is used for measuring the fairness of the pInvite model.

An ROC curve is a graphical plot that illustrates the diagnostic ability of a binary classifier system as its discrimination threshold is varied. The ROC curve is created by plotting the true positive rate (TPR) against the false positive rate (FPR) at various threshold settings.

A model satisfies the p %-rule if the following expression is satisfied:

$$min ( \frac{p ( \hat{y} = 1 \vert z = 1 )}{p ( \hat{y} = 1 \vert z = 0 )} , \frac{p ( \hat{y} = 1 \vert z = 0 )}{p ( \hat{y} = 1 \vert z = 1 )} ) \geq \frac{p}{100} \qquad ( 6 )$$

The rules states that the ratio of positive prediction of sending an invite when the destination user is an engaged user to positive prediction of sending an invite when the destination user is not an engaged user is greater than p/100. When the pInvite model has no such engagement bias, this ratio would be 1 (satisfying the 100%-rule) and when it is completely full of the engagement bias the ratio would be 0 (satisfying the 0%-rule). The p % rule was published by the US government to bring fairness into AI.

In the minimax loss function shown in equation (4), λ controls how fair the pInvite model would be, as a trade off at the cost of the invitation prediction accuracy. The hyperparameter λ is selected by choosing a reasonable trade-off between the p %-rule and the ROC AUC. The p %-rule and the ROC AUC are counteracting: the higher the p %-rule, the lower its ROC AUC (and the prediction accuracy) is.

Now, since there are millions of members in some online services, it is not likely that 2 is equal to 0.5 for all members and all destination users; there will be some degree of variability, hopefully, with an average value about 0.5. The hyperparameter λ controls how much fairness is obtained as a tradeoff of accuracy. The higher the lambda, the more weight is given to fairness, but the less weight given to accuracy. If a very high lambda were selected, then 2 would be equal to 0.5, or close to it, for most users.

To select the hyperparameter λ, cross-validation is performed. In this case a fraction of D (e.g., 30%) is not used for training and it is reserved for validation. After the model is trained, the reserved D is run through the model to obtain the value of \hat{γ}, which is then compared to the actual y value (an invitation was actually sent or not).

The p %-rule considers that the probability that a user sends an invite to another user should be the same whether the user is an engaged user or not. If they are perfectly equal, the p %-rule would generate a value of 1 (100%). However, in many systems a smaller value is also considered fair, such as 80%. It can be said that if the hyperparameter λ generates a p % of 80, then the model is not biased.

To find the best value for λ several experiments are performed. Then the λ that provides the best accuracy, while meeting the minimum p %, is selected. For example, in several experiments, the following values of p % and AUC were obtained for a test λ value, represented as (λ, p %, AUC): (0.1, 0.7, 0.9), (1, 0.9, 0.6), (10, 0.85, 0.7). If the minimum p % is 0.8, then the values of 1 and 10 for λ generate a valid p %. However, the last experiment generates higher accuracy, so the λ of 10 would be selected.

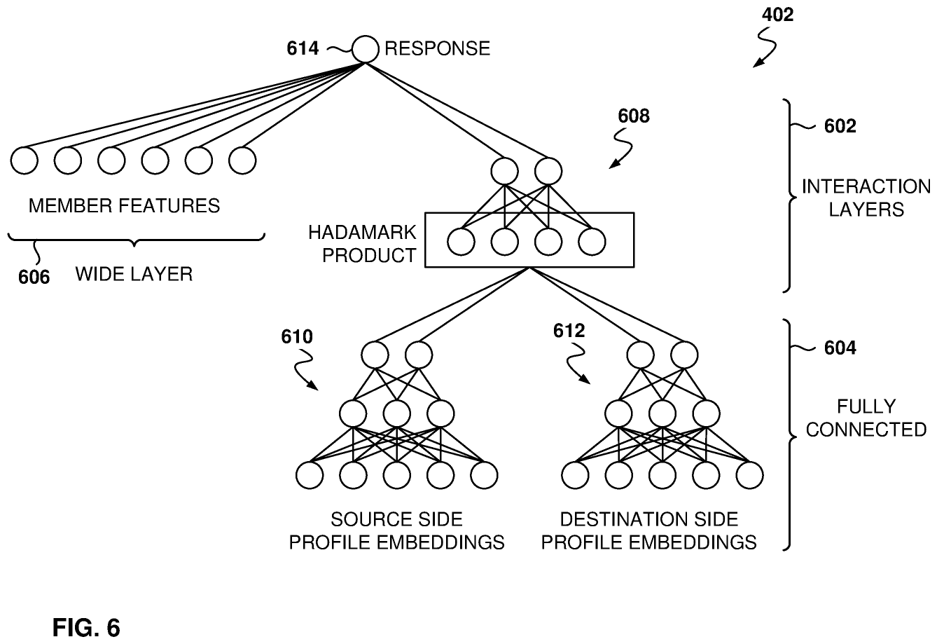

FIG. 6 is an example of a pInvite neural network 402, according to some example embodiments. The pInvite neural network 402 is a Siamese two-tower deep-n-wide NN (neural network) used to estimate a probability of sending an invite after presenting a suggestion.

The deep part is a two tower NN (for each of source and destination users) where each tower has two fully-connected layers 604. The outputs of these two towers go into interaction layers 602, which include a wide layer 606 for user features (e.g., profile features) and a hadamard or cosine interaction layer 608. Finally, in the response layer 614, a sigmoid activation function is applied to generate the probability of sending an invite.

It is noted that the embodiments illustrated in FIG. 6 are examples and do not describe every possible embodiment. Other embodiments may utilize different types of ML models, neural networks with additional layers or fewer layers, additional or fewer features, etc. The embodiments illustrated in FIG. 6 should therefore not be interpreted to be exclusive or limiting, but rather illustrative.

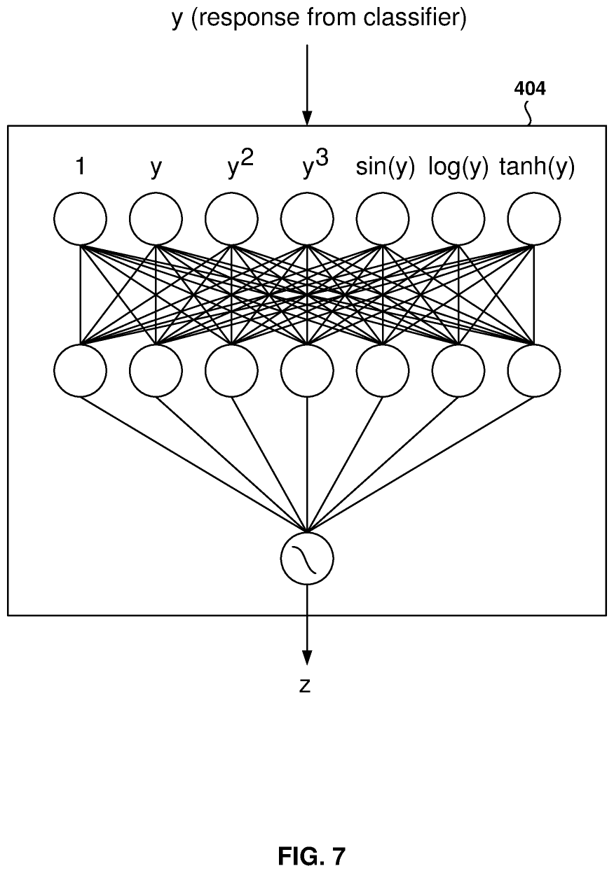

FIG. 7 is an example of an adversarial neural network 404, according to some example embodiments. In some example embodiments, r is a neural network with two fully-connected hidden layers and a sigmoid activation function in the response layer. In the input layer, the input y is the response from the classifier (estimated PYMK score) and y is lifted to seven dimensions: y⁰, y¹, y², y³, sin(y), log(y), and tanh(y).

The adversarial network r 404 infers whether the user is engaged or not. The deep layers then calculate the z. It is noted that the embodiments illustrated in FIG. 7 are examples and do not describe every possible embodiment. Other embodiments may utilize different number of layers, a different number of dimensions, use other type of machine-learning algorithms, etc. The embodiments illustrated in FIG. 7 should therefore not be interpreted to be exclusive or limiting, but rather illustrative.

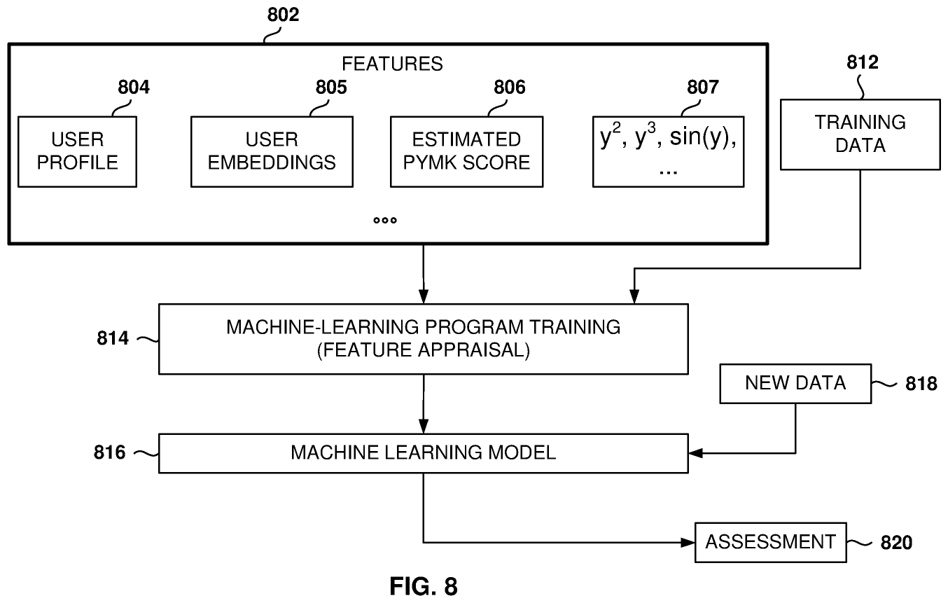

FIG. 8 illustrates the training and use of a machine-learning program, according to some example embodiments. In some example embodiments, machine-learning programs (MLPs), also referred to as machine-learning algorithms or tools, are utilized to perform operations associated with searches, such as video matching.

Machine Learning is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 816 from example training data 812 in order to make data-driven predictions or decisions expressed as outputs or assessments 820. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML models 816 a probability score for sending an invitation to another user given a suggestion by the online service. In some example embodiments, the ML model 816 is used to calculate the probability that a user is an engaged user.

The training data 812 comprises examples of values for the features 802. In some example embodiments, the training data comprises labeled data with examples of values for the features 802 and labels indicating the outcome, such as whether an invitation was sent or a user is an engaged user. The machine-learning algorithms utilize the training data 812 to find correlations among identified features 802 that affect the outcome. A feature 802 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as numeric features, strings, and graphs.

In one example embodiment, the features 802 may be of different types and may include one or more of user profile data 804 (e.g., name, address, birthday, education, skills, title, employment, posts, following), user embeddings 805 (vector comprising information about the user), the estimated PYMK score 806, and extensions on the input, as discussed above for T.

During training 814, the ML algorithm analyzes the training data 812 based on identified features 802 and configuration parameters 811 defined for the training. The result of the training 814 is an ML model 816 that is capable of taking inputs to produce assessments.

Training an ML algorithm involves analyzing large amounts of data (e.g., from several gigabytes to a terabyte or more) in order to find data correlations. The ML algorithms utilize the training data 812 to find correlations among the identified features 802 that affect the outcome or assessment 820. In some example embodiments, the training data 812 includes labeled data, which is known data for one or more identified features 802 and one or more outcomes, such as the existence of a near duplicate.

The ML algorithms usually explore many possible functions and parameters before finding what the ML algorithms identify to be the best correlations within the data; therefore, training may require large amounts of computing resources and time.

When the ML model 816 is used to perform an assessment, new data 818 is provided as an input to the ML model 816, and the ML model 816 generates the assessment 820 as output. For example, when suggestion for an invitation is provided, the ML model 816 calculates the probability that the invitation is sent.

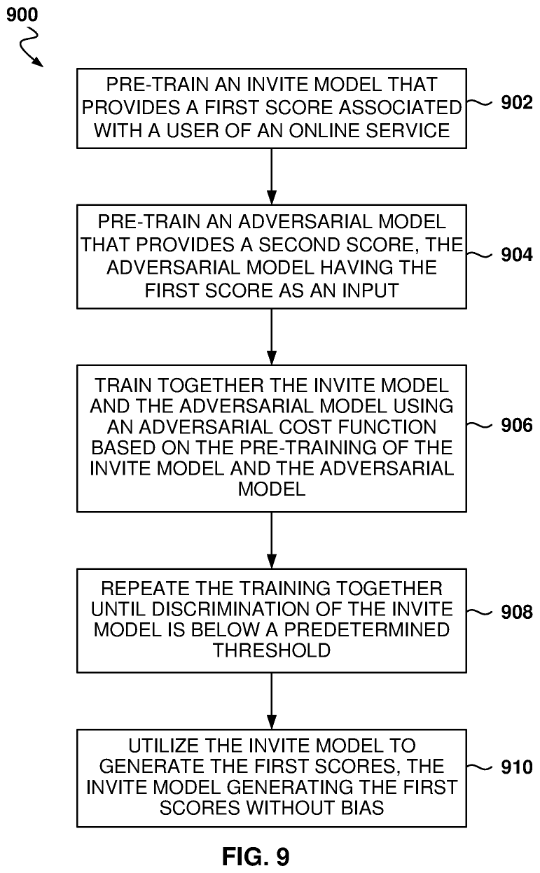

FIG. 9 is a flowchart of a method 900 for removing bias among users of an online service based on the amount of user's participation in the online service. While the various operations in this flowchart are presented and described sequentially, one of ordinary skill will appreciate that some or all of the operations may be executed in a different order, be combined or omitted, or be executed in parallel.

Operation 902 is for pre-training, by one or more processors, an invite model that provides a first score associated with a user of an online service. From operation 902, the method 900 flows to operation 904 for pre-training, by the one or more processors, an adversarial model that provides a second score. The adversarial model has the first score as an input.

From operation 104, the method 900 flows to operation 906 for training, by the one or more processors, together the invite model and the adversarial model using an adversarial cost function based on the pre-training of the invite model and the adversarial model.

At operation 908, the training together of operation 906 is repeated until discrimination of the invite model is below a predetermined threshold.

From operation 908, the method 900 flows to operation 910 where by the one or more processors utilize the invite model to generate the first scores, the invite model generating the first scores without bias.

In one example, the first score is a probability that an invitation is sent from a first user to a second user, and the second score is a probability that the second user in an engaged user that participates in an online service with at least a predetermined frequency.

In one example, a training set for the training includes captured values, for a predetermined period, of user activities in the online service.

In one example, the training set includes a plurality of features that comprise user profile information, user activity, and invitations to connect sent by users of the online service.

In one example, the adversarial cost function includes a first term minus a second term, the first term associated with minimizing loss for the invite model, the second term being for maximizing a loss function of the adversarial model, the second term having a λ parameter to tune accuracy of the invite model versus amount of bias in the invite model.

In one example, the method 900 further comprises tuning the λ parameter by performing several experiments with different values of the λ parameter and determining the accuracy and the bias, and selecting the a λ parameter that provides best accuracy for a minimum amount of bias.

In one example, the pre-training of the invite model includes minimizing a first cost function, wherein the pre-training of the adversarial model includes minimizing a second cost function.

In one example, the invite model is a Siamese two-tower neural network.

In one example, the adversarial model is a neural network with two fully-connected hidden layers and an input that is an output of the invite model.

In one example, the method 900 further comprises performing an experiment to test functionality of the online service, the experiment including measuring the first score, wherein the experiment is without bias due to frequency of use of the online service by users.

Another general aspect is for a system that includes a memory comprising instructions and one or more computer processors. The instructions, when executed by the one or more computer processors, cause the one or more computer processors to perform operations comprising: pre-training an invite model that provides a first score associated with a user of an online service; pre-training an adversarial model that provides a second score, the adversarial model having the first score as an input; training together the invite model and the adversarial model using an adversarial cost function based on the pre-training of the invite model and the adversarial model; repeating the training together until discrimination of the invite model is below a predetermined threshold; and utilizing the invite model to generate the first scores, the invite model generating the first scores without bias.

In yet another general aspect, a machine-readable storage medium (e.g., a non-transitory storage medium) includes instructions that, when executed by a machine, cause the machine to perform operations comprising: pre-training an invite model that provides a first score associated with a user of an online service; pre-training an adversarial model that provides a second score, the adversarial model having the first score as an input; training together the invite model and the adversarial model using an adversarial cost function based on the pre-training of the invite model and the adversarial model; repeating the training together until discrimination of the invite model is below a predetermined threshold; and utilizing the invite model to generate the first scores, the invite model generating the first scores without bias.

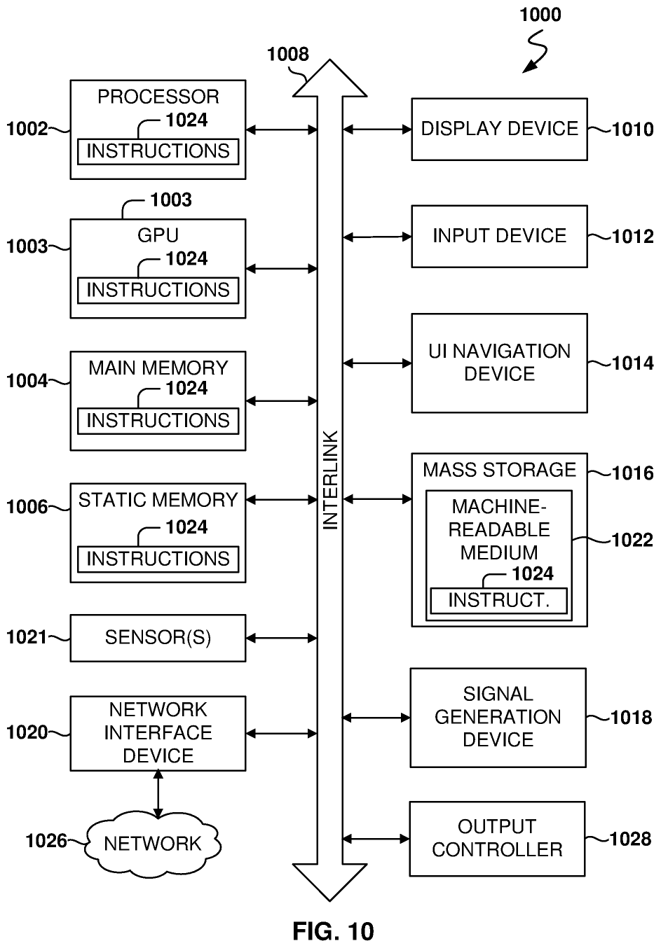

FIG. 10 is a block diagram illustrating an example of a machine 1000 upon or by which one or more example process embodiments described herein may be implemented or controlled. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry usership may be flexible over time and underlying hardware variability. Circuitries include users that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create users of the circuitry in hardware via the variable connections to carry out portions of the specific operation when in operation. Accordingly, the computer-readable medium is communicatively coupled to the other components of the circuitry when the device is operating. In an example, any of the physical components may be used in more than one user of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a hardware processor core, or any combination thereof), a graphics processing unit (GPU) 1003, a main memory 1004, and a static memory 1006, some or all of which may communicate with each other via an interlink (e.g., bus) 1008. The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device (e.g., drive unit) 1016, a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, within the hardware processor 1002, or within the GPU 1003 during execution thereof by the machine 1000. In an example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium, or multiple media, (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that cause the machine 1000 to perform any one or more of the techniques of the present disclosure, or that is capable of storing, encoding, or carrying data structures used by or associated with such instructions 1024. Non-limiting machine-readable medium examples may include solid-state memories, and optical and magnetic media. In an example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
pre-training, by one or more processors, an invite model that provides a first score associated with a user of an online service;
pre-training, by the one or more processors, an adversarial model that provides a second score, the adversarial model having the first score as an input;
training, by the one or more processors, together the invite model and the adversarial model using an adversarial cost function based on the pre-training of the invite model and the adversarial model;
repeating the training together until discrimination of the invite model is below a predetermined threshold; and
utilizing, by the one or more processors, the invite model to generate the first scores, the invite model generating the first scores without bias.

2. The method as recited in claim 1, wherein the first score is a probability that an invitation is sent from a first user to a second user, wherein the second score is a probability that the second user in an engaged user that participates in an online service with at least a predetermined frequency.

3. The method as recited in claim 1, wherein a training set for the training includes captured values, for a predetermined period, of user activities in the online service.

4. The method as recited in claim 3, wherein the training set includes a plurality of features that comprise user profile information, user activity, and invitations to connect sent by users of the online service.

5. The method as recited in claim 1, wherein the adversarial cost function includes a first term minus a second term, the first term associated with minimizing loss for the invite model, the second term being for maximizing a loss function of the adversarial model, the second term having a λ parameter to tune accuracy of the invite model versus amount of bias in the invite model.

6. The method as recited in claim 5, further comprising:
tuning the λ parameter by performing several experiments with different values of the λ parameter and determining the accuracy and the bias; and
selecting the a λ parameter that provides best accuracy for a minimum amount of bias.

7. The method as recited in claim 1, wherein the pre-training of the invite model includes minimizing a first cost function, wherein the pre-training of the adversarial model includes minimizing a second cost function.

8. The method as recited in claim 1, wherein the invite model is a Siamese two-tower neural network.

9. The method as recited in claim 1, wherein the adversarial model is a neural network with two fully-connected hidden layers and an input that is an output of the invite model.

10. The method as recited in claim 1, further comprising:
performing an experiment to test functionality of the online service, the experiment including measuring the first score, wherein the experiment is without bias due to frequency of use of the online service by users.

11. A system comprising:
a memory comprising instructions; and
one or more computer processors, wherein the instructions, when executed by the one or more computer processors, cause the system to perform operations comprising:
pre-training an invite model that provides a first score associated with a user of an online service;
pre-training an adversarial model that provides a second score, the adversarial model having the first score as an input;
training together the invite model and the adversarial model using an adversarial cost function based on the pre-training of the invite model and the adversarial model;
repeating the training together until discrimination of the invite model is below a predetermined threshold; and
utilizing the invite model to generate the first scores, the invite model generating the first scores without bias.

12. The system as recited in claim 11, wherein the first score is a probability that an invitation is sent from a first user to a second user, wherein the second score is a probability that the second user in an engaged user that participates in an online service with at least a predetermined frequency.

13. The system as recited in claim 11, wherein a training set for the training includes captured values, for a predetermined period, of user activities in the online service, wherein the training set includes a plurality of features that comprise user profile information, user activity, and invitations to connect sent by users of the online service.

14. The system as recited in claim 11, wherein the adversarial cost function includes a first term minus a second term, the first term associated with minimizing loss for the invite model, the second term being for maximizing a loss function of the adversarial model, the second term having a λ parameter to tune accuracy of the invite model versus amount of bias in the invite model.

15. The system as recited in claim 11, wherein the instructions further cause the one or more computer processors to perform operations comprising:
tuning the λ parameter by performing several experiments with different values of the λ parameter and determining the accuracy and the bias; and
selecting the λ parameter that provides best accuracy for a minimum amount of bias.

16. A non-transitory machine-readable storage medium including instructions that, when executed by a machine, cause the machine to perform operations comprising:
pre-training an invite model that provides a first score associated with a user of an online service;
pre-training an adversarial model that provides a second score, the adversarial model having the first score as an input;
training together the invite model and the adversarial model using an adversarial cost function based on the pre-training of the invite model and the adversarial model;
repeating the training together until discrimination of the invite model is below a predetermined threshold; and
utilizing the invite model to generate the first scores, the invite model generating the first scores without bias.

17. The non-transitory machine-readable storage medium as recited in claim 16, wherein the first score is a probability that an invitation is sent from a first user to a second user, wherein the second score is a probability that the second user in an engaged user that participates in an online service with at least a predetermined frequency.

18. The non-transitory machine-readable storage medium as recited in claim 16, wherein a training set for the training includes captured values, for a predetermined period, of user activities in the online service, wherein the training set includes a plurality of features that comprise user profile information, user activity, and invitations to connect sent by users of the online service.

19. The non-transitory machine-readable storage medium as recited in claim 16, wherein the adversarial cost function includes a first term minus a second term, the first term associated with minimizing loss for the invite model, the second term being for maximizing a loss function of the adversarial model, the second term having a λ parameter to tune accuracy of the invite model versus amount of bias in the invite model.

20. The non-transitory machine-readable storage medium as recited in claim 19, wherein the machine further performs operations comprising:
tuning the λ parameter by performing several experiments with different values of the λ parameter and determining the accuracy and the bias; and
selecting the a λ parameter that provides best accuracy for a minimum amount of bias.
